(19) United States
(12) Patent Application Publication
(10) Pub. No.: US 2026/0121410 A1
(43) Pub. Date: Apr. 30, 2026

(54) SOFTWARE DEFINED CIRCUIT BREAKER AND POWER QUALITY MONITORING SYSTEM AND METHOD

(71) Applicant: Switch, Ltd., Las Vegas, NV (US)

(72) Inventors: Zia SYED, Los Altos, CA (US); Jason Hoffman, Las Vegas, NV (US); Rob Roy, Las Vegas, NV (US)

(21) Appl. No.: 19/371,268

(22) Filed: Oct. 28, 2025

Related U.S. Application Data
(60) Provisional application No. 63/774,439, filed on Mar. 19, 2025.
(60) Provisional application No. 63/712,886, filed on Oct. 28, 2024.

(51) Int. Cl. H02J 3/00; H02J 3/01; H02J 13/00

(52) U.S. Cl. CPC H02J 3/007; H02J 3/0012; H02J 3/01; H02J 13/12; H02J 13/34; H02J 2105/425; H02J 2105/52

(57) ABSTRACT

A system and method for managing power analysis and power allocation in a high density computing environment. The system includes at least one edge computing device that receives power budget information from at least one high density computing workload scheduler, at least one power quality monitor that collects power quality measurements across three-phase power distribution, at least one programmable relay with at least one adjustable threshold, and at least one process controller that adjusts the at least one threshold of the at least one programmable relay based on at least one of the power budget information and the power quality measurements.

### CROSS-REFERENCE TO RELATED APPLICATIONS

This utility patent application claims the benefit of and priority to the following U.S. provisional patent applications, serial no. 63/712,886, filed on October 28, 2024 and serial no. 63/774,439 filed on March 19, 2025, the entire disclosure of both which are hereby incorporated by reference in their entirety.

### TECHNICAL FIELD

The present disclosure relates to software and hardware for power management. More particularly, present disclosure relates to a software defined circuit breaker and power quality monitoring system for managing power analysis and power allocation within a datacenter.

### BACKGROUND

Data centers are known to consume large amounts of power. This can be attributed to fluctuating demand loads from various power consuming equipment that can be found in a data center. How power is allocated amongst this equipment directly impacts the efficiency, sustainability, and operational costs of the datacenter. This is particularly true for high-density computing environments like data centers managing AI or high performance computing (HPC) workloads. Historically AI or HPC workload schedulers have been employed to improve the efficiency of a data center, by focusing in three main areas. Optimizing the use of CPU’s/GPU’s for performance, ensuring low latency and efficient data transmission, and the management of data placement, access speed, and availability.

The operational efficiency of a data center can also be impacted by the ability of the grid to supply consistent power. External factors like extreme weather conditions or sudden load increases cause sharp spikes in electricity demand. Power grids are built to supply an average or baseline demand, resulting in the grid consistently needing help to meet peak demand due to sudden load surges. During peak demand periods the grid may fail to supply full amperage, which results in voltage sags or the need to load shed. This variability in supply can be detrimental to operations at a data center, especially those requiring high reliability, or large power loads.

With fluctuations in grid capacity, renewable energy integration, and increasing energy costs, power management has become an essential variable in workload optimization and overall data center efficiency.

### SUMMARY

An aspect of the disclosed embodiments includes a system for managing power analysis and power allocation in a high density computing environment. The system includes at least one edge computing device that receives power budget information from at least one high density computing workload scheduler, at least one power quality monitor that collects power quality measurements across three-phase power distribution, at least one programmable relay with at least one adjustable threshold, and at least one process controller that adjusts the at least one threshold of the at least one programmable relay based on at least one of the power budget information and the power quality measurements.

Another aspect of the disclosed embodiments includes a method for dynamic power management in a high density computing environment. The method includes collecting, by at least one edge computing device, first input information from an energy generator corresponding to a load shaving demand response request; Collecting, by the at least one edge computing device, second input information from a high density computing workload scheduler, the second input information being based on power budget information of a load interfacing with the high density computing workload scheduler; Generating, first response information based on the second input information, wherein the first response information indicates a power consumption commitment; Communicating, by the at least one edge computing device, the first response information to the energy generator; Generating first command information based on the power consumption commitment, the first input information, and the second input information; and communicating, by at least one process controller, the first command information to at least one programmable relay causing at least one threshold of the at least one programmable relay to be adjusted.

Another aspect of the disclosed embodiments includes a system for dynamic power management in a data center. The system includes a processor, and a memory. The memory includes instructions that, when executed by the processor, cause the processor to collect, by at least one edge computing device, first input information from an energy generator corresponding to a load shaving demand response request; Collect, by the at least one edge computing device, second input information from a high density computing workload scheduler, the second input information being based on power budget information of a load interfacing with the high density computing workload scheduler; Generate, first response information based on the second input information, wherein the first response information indicates a power consumption commitment; Communicate, by the at least one edge computing device, the first response information to the energy generator; Generate first command information based on the power consumption commitment, the first input information, and the second input information; and communicate, by at least one process controller, the first command information to at least one programmable relay causing at least one threshold of the at least one programmable relay to be adjusted.

### BRIEF DESCRIPTION OF THE DRAWINGS

These and other advantages of the present disclosure will be more readily understood by reference to the following description in combination with the accompanying drawings wherein:

FIG. 1 is a system diagram of a preferred embodiment of the software defined circuit breaker and power quality monitoring system, according to the principles of the present disclosure;

FIG. 2 is an exemplary architecture of the software defined circuit breaker and power quality monitoring system;

FIG. 3 is an application diagram of the software defined circuit breaker and power quality monitoring system according to the principles of the present disclosure;

FIG. 4 is a diagram of a method for dynamic power management utilizing a software define circuit breaker and power quality monitoring system, according to the principles of the present disclosure;

FIG. 5 depicts a flowchart of a method for dynamic power management utilizing a software define circuit breaker and power quality monitoring system, according to the principles of the present disclosure;

FIG. 6 depicts a flowchart of a method for dynamic power management utilizing a software define circuit breaker and power quality monitoring system, according to the principles of the present disclosure;

FIG. 7 is a block diagram of an example computing device that may be used to implement embodiments, according to the principles of the disclosure.

### DETAILED DESCRIPTION OF THE ENABLING EMBODIMENTS

Example embodiments will now be described more fully with reference to the accompanying drawings. According to the teachings of the present disclosure there is provided a software defined circuit breaker and power quality system for managing power quality analysis and allocation in a data center, the system including a combination of software and hardware systems. The software and hardware systems include an edge computing device for IT Network integration, and a process controller for interfacing with physical processes like power distribution. The edge computing device and process controller being two independent subsystems. The software and hardware systems further including high power rated sensors for accurately measuring key power quality parameters, and high current relay switches with programmable thresholds for enabling automated protection and control mechanisms.

Accordingly, the software defined circuit breaker and power quality system integrates environmental systems, generators, electrical grids, and electrical systems before and after the meter in data center facilities. The software defined circuit breaker and power quality system provides comprehensive power quality analysis and enables real-time power allocation across various subsystems and customer workloads within the data center.

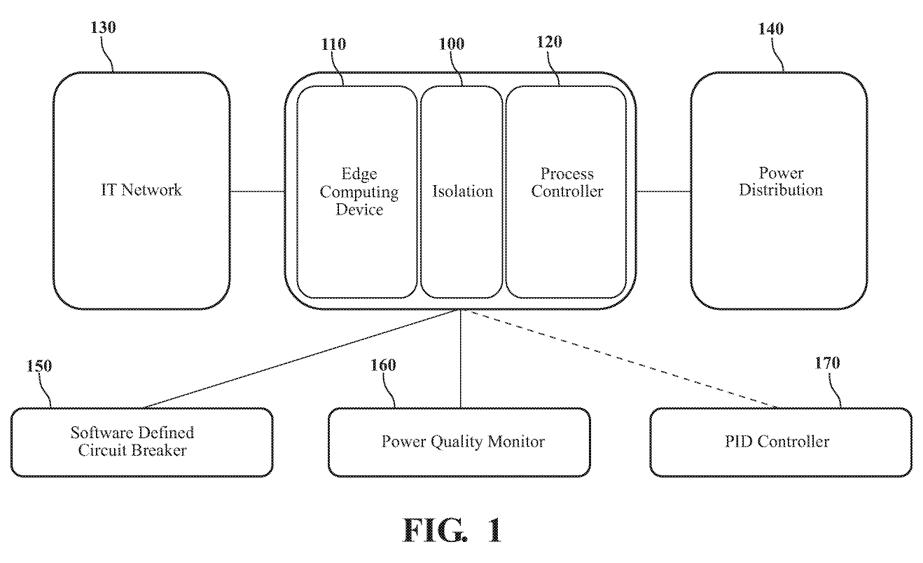

FIG. 1, generally illustrates a software defined circuit breaker and power quality monitoring system 100 for managing power analysis and allocation within a datacenter. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

More particularly, referring to the figures, wherein like numerals indicate corresponding parts throughout the several illustrations, embodiments of a software defined circuit breaker and power quality monitoring system 110 are shown for managing power analysis and allocation within a datacenter. More particularly, as shown in FIGS. 1-6, the system 110 monitors and manage power quality in data centers, ensuring operational reliability and efficiency by detecting and mitigating power anomalies such as voltage sags, swells, and harmonics. The system 110 provides real-time data, enables proactive maintenance, reduces downtime, and supports energy optimization strategies. The system 110 enhances the resilience of data center operations, ensuring uninterrupted performance and scalability. It should be appreciated that the software defined circuit breaker and power quality monitoring system 110 is configured to be compatible with any high-density computing environment.

FIG. 1 generally illustrates a system diagram of a preferred embodiment of the software defined circuit breaker and power quality monitoring system 110, according to the principles of the present disclosure. In some embodiments, the software defined circuit breaker and power quality monitoring system 110 includes two independent subsystems. A process controller 120 for interfacing with physical processes like power distribution systems 140, and an edge computing device 110 for integration with IT networks 130. The process controller 120 is configured to monitor and control circuit breakers, and the edge computing device 110 ensures high availability for diagnostics during power failures and provides real-time data streaming with secure API endpoints. The software defined circuit breaker and power quality monitoring system 100 further includes a software defined circuit breaker 150 and a power quality monitor 160 which are both in communication with, and controlled by the process controller 120. The software defined circuit breaker and power quality monitoring system 100 is configured to be modular which enables connections to various new, or existing process controller boards, application boards, external networks, building management systems, power management systems, data infrastructure management systems, and chemistry monitoring systems. In some embodiments, the software defined circuit breaker and power quality monitoring system 100 includes a plurality of process controllers 120 and/or a plurality of edge computing devices 110, which enables scalability.

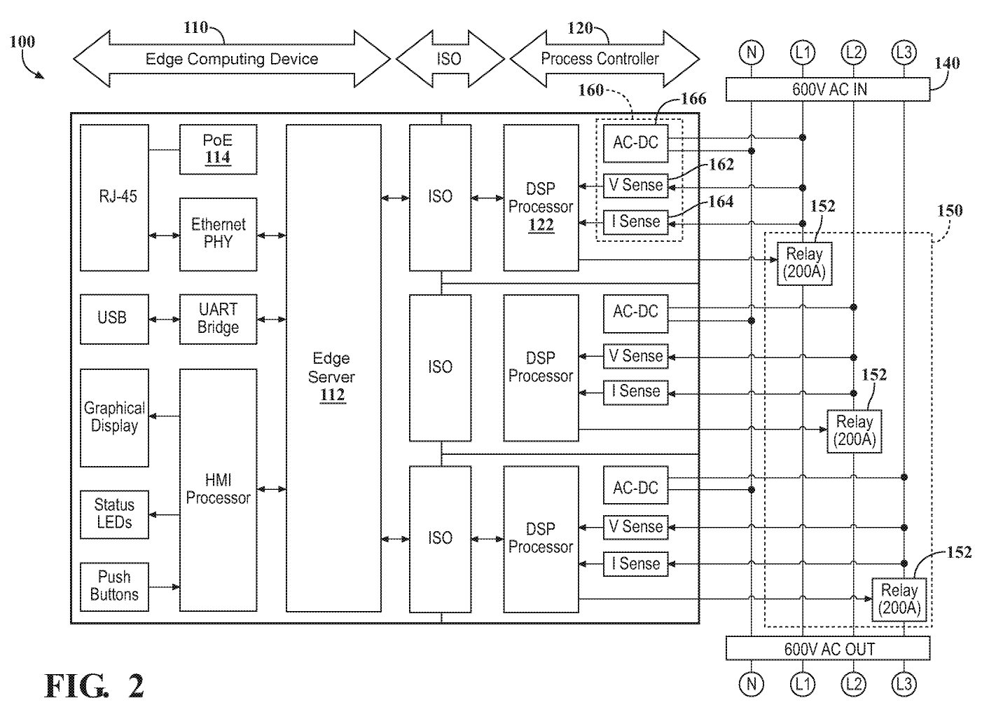

FIG. 2 generally illustrates an exemplary architecture of the software defined circuit breaker and power quality system 100. In some embodiments, the software defined circuit breaker and power quality monitoring system 110 further includes critical components to ensure high performance and reliability. In an exemplary embodiment of the invention the power quality monitor 160 is comprised of a plurality of high power rated sensors that accurately measure key power quality parameters across three-phase power distribution 140. The plurality of high power rated sensors include a voltage sensor 162, a current sensor 164, and a frequency sensor 166. The plurality of high power rated sensors are configured to sample at approximately 10 microsecond intervals. In an exemplary embodiment of the invention the software defined circuit breaker 150 is comprised of at least one high-current programmable relay 152. The programmable relay 152 has an adjustable fault threshold and is configured to enforce adjustable power consumption levels, while enabling automated protection and control mechanisms.

The software defined circuit breaker and power quality monitoring system 110, also includes DSP processor 122 that uses advanced algorithms to perform real-time processing of the measured data received from the power quality monitor 160. The algorithms utilized by the DSP processor 122 are capable of detecting anomalies, such as phase imbalance and harmonic distortions, providing detailed insights into the power system’s performance. The DSP processor 122 is powered directly by the measured power line, allowing it to operate independently of external power sources. As generally illustrated in FIG. 2, the edge computing device 110 further includes an embedded edge server 112, powered by a Power over Ethernet (PoE) module 114. The PoE module 114 ensures the embedded edge server 112 remains operational even during power failures. The embedded edge server 114 implements a comprehensive networking stack for streamlined, low-latency connectivity to the IT network 130, while ensuring real-time data transfer. The edge computing device 110 also includes high level software API’s that enable the software defined circuit breaker and power quality monitoring system 110 to integrate with external systems. The edge computing device 110 analyzes power quality utilizing highly scalable distributed processing, which generates actionable information instead of raw data. The edge computing device 110 also provides robust diagnostics and predictive maintenance capability, which minimizes operational failures and downtime in a data center.

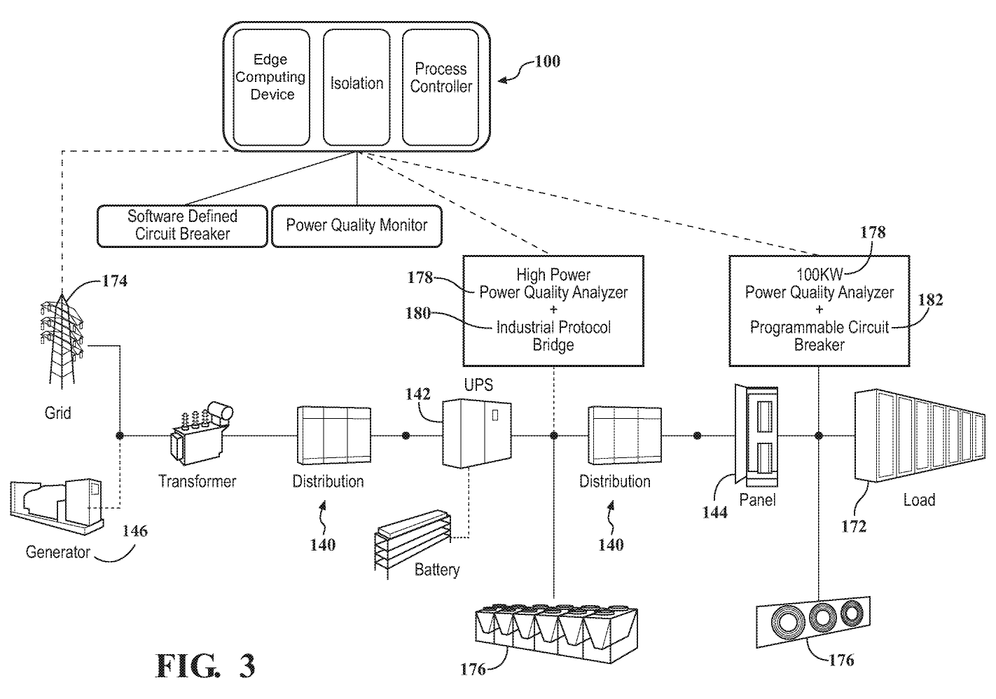

FIG. 3 generally illustrates an application diagram of the software defined circuit breaker and power quality monitoring system 100, according to the principles of the present disclosure. In some embodiments, the software defined circuit breaker and power quality monitoring system 100 is also configured to manage power across a range of high and low power systems, including but not limited to uninterruptable power supplies (UPS) 142, and remote power panels (RPP) 144, and fuel powered generators 146. In some embodiments The modular design and scalability of the software defined circuit breaker and power quality monitoring system 100 allows it to interface and manage power across diverse applications found in a datacenter, including but not limited to PID controllers 170 (as shown in FIG. 1), AI workload schedulers, high performance computing (HPC) workload schedulers 172, grid networks 174, environmental systems 176 (i.e. fans, liquid cooling systems), power quality analyzers 178, industrial protocol bridges 180, and programmable circuit breakers 182. In some embodiments, the software designed circuit breaker and power quality system 100 may interface with other applications found in a data center, including hydronic chemistry monitoring systems, air handling systems, humidity and dew point control systems, air quality and volatile organic compound sensing systems, battery energy storage systems, automatic transfer switches, power distribution units, solid state power controllers, and micro-grid controllers. In some embodiments, diverse applications the software designed circuit breaker and power quality system 100 may interface with, further includes AI model training and inference nodes, enterprise virtualization and cloud-native workloads, and colocation customer IT infrastructures. The high level software API’s facilitate communication between the software defined circuit breaker and power quality monitoring system 100 and other external systems, both upstream and downstream of the meter. Through communications with external systems, the software defined circuit breaker and power quality monitoring system 100 is able to monitor power quality, and manage power allocation across a myriad of applications and systems utilized in a data center.

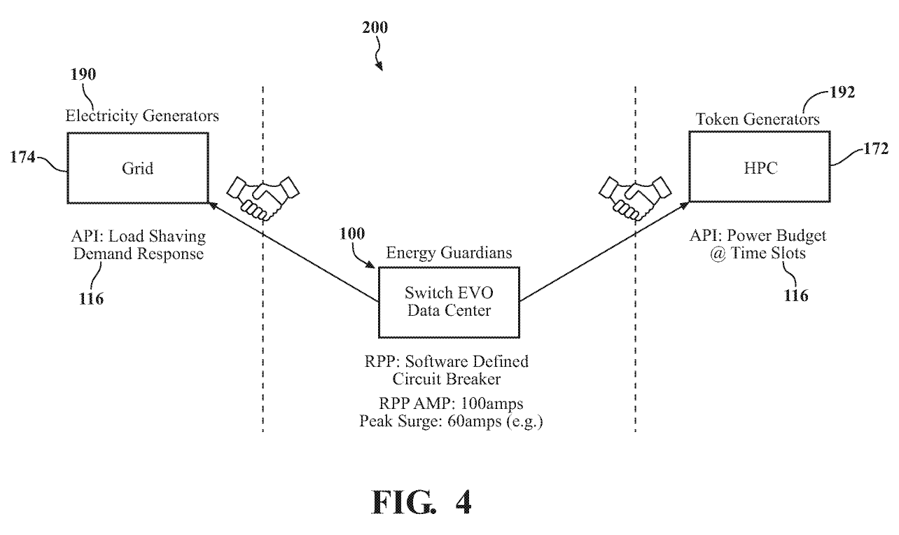

FIG. 4 generally illustrates a diagram of a method 200 for dynamic power management in data centers, utilizing a software defined circuit breaker and power quality monitoring system 100, according to the principles of the present disclosure. In some embodiments the method 200 may include communicating with an energy generator 190 through a grid network 174 utilizing a high level software API 116, to receive first input information corresponding to a load shaving demand response. In some embodiments the energy generator 190 may be a system capable of any combination of generating, storing, or supplying energy. In some embodiments the energy generator 190 may be an uninterruptable power supply (UPS) 142, a fuel powered generator 146, or a utility company. The method 200 may further include communicating with a token generator 192 utilizing a high level software API 116 to receive second input information corresponding to a power budget. In some embodiments the token generator 192 may be any type of high density computing workload scheduler, including but not limited to AI workload schedulers, and high performance computing (HPC) workload schedulers 172 configured to manage large language model (LLM) tokens. The method 200 may further include communicating first response information to the energy generator 190, based on the second input information from the token generator 192, utilizing a high level software API 116. According to an embodiment the method 200 may include communicating first command information to a software defined circuit breaker 150, corresponding to a request to adjust power consumption levels based on the first input information from the energy generator 190, and the second input information from the token generator 192. The method 200 for dynamic power management enables high density computing workload schedulers to participate in demand response programs, which reduces power loads during peak grid demand, improving both sustainability and cost savings.

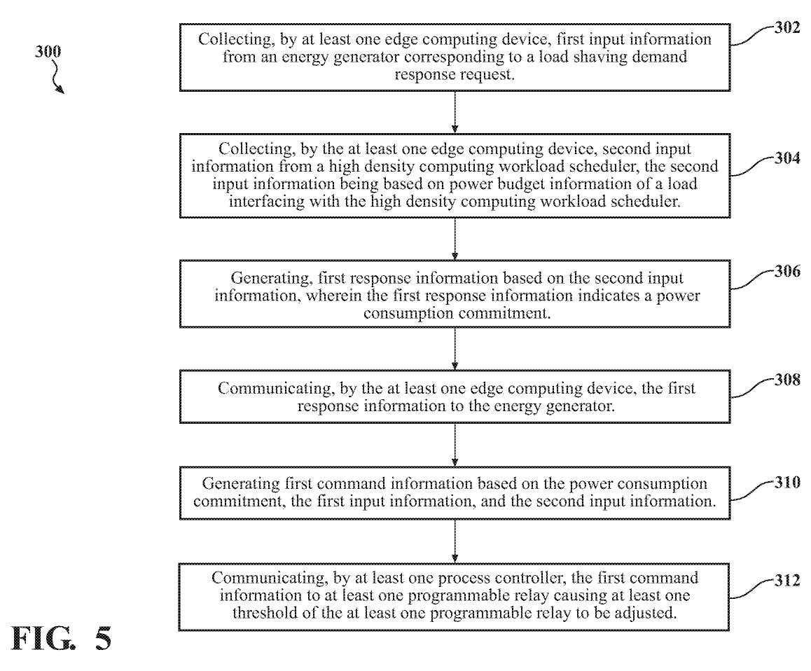

FIG. 5 generally illustrates a flowchart of a method 300 for dynamic power management in data centers, utilizing a software defined circuit breaker and power quality monitoring system 100, according to the principles of the present disclosure. The flowchart of method 300 begins at step 302. In step 302, at least one edge computing device 110 collects first input information from an energy generator 190 corresponding to a load shaving demand response request. At step 304, the at least one edge computing device 110 collects second input information from a high density computing workload scheduler corresponding to power budget information of a load interfacing with the high density computing workload scheduler. At step 306, first response information is generated based on the second input information, wherein the first response information indicates a power consumption commitment. At step 308, the at least one edge computing device 110 communicates the first response information to the energy generator 190.

At step 310, first command information is generated based on the power consumption commitment, the first input information, and the second input information. At step 312, at least one process controller 120 communicates the first command information to at least one programmable relay 152 causing at least one threshold of the at least one programmable relay 152 to be adjusted.

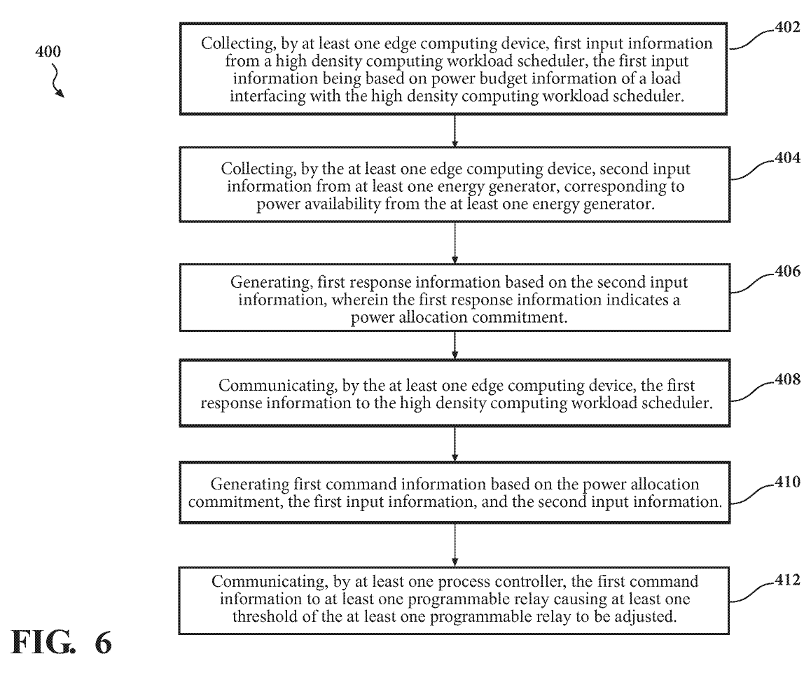

FIG. 6 generally illustrates a flowchart of a method 400 for dynamic power management in data centers, utilizing a software defined circuit breaker and power quality monitoring system 100, according to the principles of the present disclosure. The flowchart of method 400 begins at step 402. At step 402, the at least one edge computing device 110 collects first input information from a high density computing workload scheduler corresponding to power budget information of a load interfacing with the high density computing workload scheduler. At step 404, the at least one edge computing device 110 collects second input information from at least one energy generator 190 corresponding to power availability from the at least one energy generator 190. At step 406, first response information is generated based on the second input information, wherein the first response information indicates a power allocation commitment. At step 408, the at least one edge computing device 110 communicates the first response information to the high density computing workload scheduler. At step 410, first command information is generated based on the power allocation commitment, the first input information, and the second input information. At step 412, at least one process controller 120 communicates the first command information to at least one programmable relay 152 causing at least one threshold of the at least one programmable relay 152 to be adjusted.

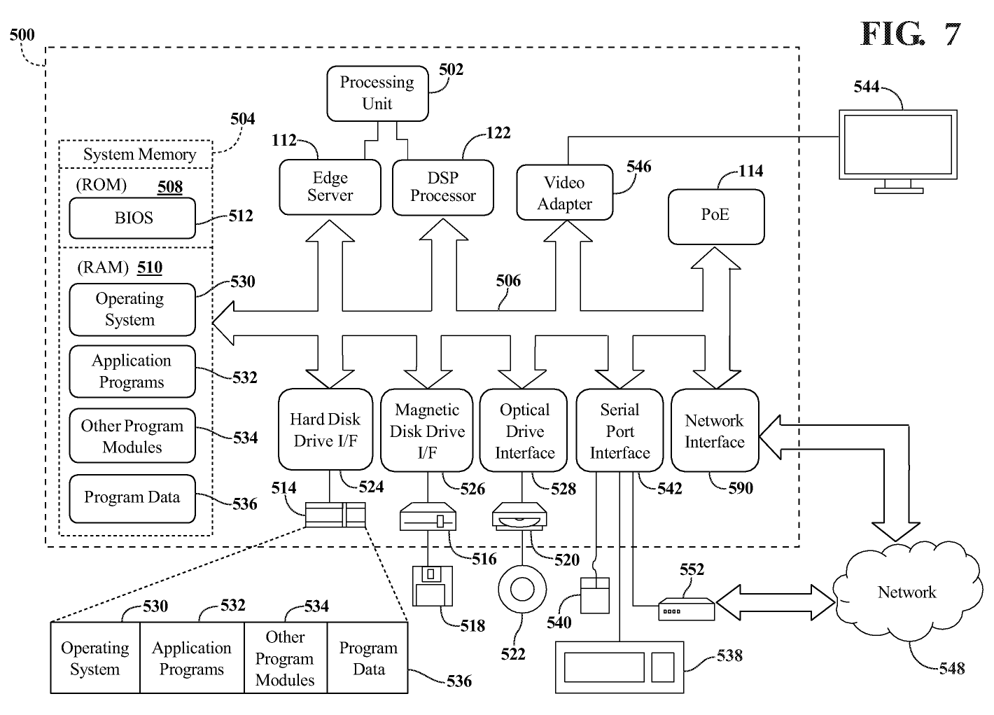

FIG. 7 depicts an example processor-based computer system 500 that may be used to implement various embodiments described herein, such as any of the embodiments described in the above and in reference to FIGS. 1-6. For example, processor-based computer system 500 may be used to implement any of the components of the software defined circuit breaker and power quality monitoring system 100 as described above in reference to FIGS. 1-6. The description of processor-based computer system 500 provided herein is provided for purposes of illustration and is not intended to be limiting. Embodiments may be implemented in further types of computer systems, as would be known to persons skilled in the relevant art(s).

As shown in FIG. 7, processor-based computer system 500 includes one or more processors, referred to as processor circuit 502, a system memory 504, and a bus 506 that couples various system components including system memory 504 to processor circuit 502. Processor circuit 502 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. In some embodiments, the processor circuit 502, may include an edge server 112, and/or a DSP processor 122. In some embodiments, the edge server 112 is powered by a Power over Ethernet (PoE) module 114. Processor circuit 502 may execute program code stored in a computer readable medium, such as program code of operating system 530, application programs 532, other programs 534, etc. Bus 506 represents one or more of any of several types of bus structures, including a memory bus or memory controller, a peripheral bus, an accelerated graphics port, and a processor or local bus using any of a variety of bus architectures. System memory 504 includes read only memory (ROM) 508 and random access memory (RAM) 510. A basic input/output system 512 (BIOS) is stored in ROM 508.

Processor-based computer system 500 also has one or more of the following drives: a hard disk drive 514 for reading from and writing to a hard disk, a magnetic disk drive 516 for reading from or writing to a removable magnetic disk 518, and an optical disk drive 520 for reading from or writing to a removable optical disk 522 such as a CD ROM, DVD ROM, or other optical media. Hard disk drive 514, magnetic disk drive 516, and optical disk drive 520 are connected to bus 506 by a hard disk drive interface 524, a magnetic disk drive interface 526, and an optical drive interface 528, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 530, one or more application programs 532, other programs 534, and program data 536. Application programs 532 or other programs 534 may include, for example, computer program logic (e.g., computer program code or instructions) for implementing the systems described above, including the embodiments described in reference to FIGS. 1-6.

A user may enter commands and information into processor-based computer system 500 through input devices such as keyboard 538 and pointing device 540. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 502 through a serial port interface 542 that is coupled to bus 506, but may be connected by other interfaces, such as a parallel port, game port, or a universal serial bus (USB).

A display screen 544 is also connected to bus 506 via an interface, such as a video adapter 546. Display screen 544 may be external to, or incorporated in processor-based computer system 500. Display screen 544 may display information, as well as being a user interface for receiving user commands and/or other information (e.g., by touch, finger gestures, virtual keyboard, etc.). In addition to display screen 544, processor-based computer system 500 may include other peripheral output devices (not shown) such as speakers and printers.

Processor-based computer system 500 is connected to a network 548 (e.g., the Internet) through an adaptor or network interface 550, a modem 552, or other means for establishing communications over the network. Modem 552, which may be internal or external, may be connected to bus 506 via serial port interface 542, as shown in FIG. 5, or may be connected to bus 506 using another interface type, including a parallel interface.

As used herein, the terms "computer program medium," "computer-readable medium," and “computer-readable storage medium” are used to generally refer to physical hardware media such as the hard disk associated with hard disk drive 514, removable magnetic disk 518, removable optical disk 522, other physical hardware media such as RAMs, ROMs, flash memory cards, digital video disks, zip disks, MEMs, nanotechnology-based storage devices, and further types of physical/tangible hardware storage media (including system memory 504 of FIG. 5). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 532 and other programs 534) may be stored on the hard disk, magnetic disk, optical disk, ROM, RAM, or other hardware storage medium. Such computer programs may also be received via network interface 550, serial port interface 542, or any other interface type. Such computer programs, when executed or loaded by an application, enable processor-based computer system 500 to implement features of embodiments discussed herein. Accordingly, such computer programs represent controllers of processor-based computer system 500.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A system for managing power analysis and power allocation in a high density computing environment, the system comprising:
at least one edge computing device that receives power budget information from at least one high density computing workload scheduler;
at least one power quality monitor that collects power quality measurements across three-phase power distribution;
at least one programmable relay with at least one adjustable threshold; and
at least one process controller that adjusts the at least one threshold of the at least one programmable relay based on at least one of the power budget information and the power quality measurements.

2. The system of claim 1, further comprising the at least one edge computing device receiving additional power budget information from at least one process controller board, wherein the at least one process controller adjusts the at least one threshold of the at least one programmable relay based on the additional power budget information .

3. The system of claim 1, further comprising the at least one edge computing device receiving additional power budget information from at least one application board, wherein the at least one process controller adjusts the at least one threshold of the at least one programmable relay based on the additional power budget information.

4. The system of claim 1, further comprising the at least one edge computing device receiving additional power budget information from at least one external network, wherein the at least one process controller adjusts the at least one threshold of the at least one programmable relay based on the additional power budget information.

5. A method for dynamic power management in a high density computing environment, the method comprising:
collecting, by at least one edge computing device, first input information from an energy generator corresponding to a load shaving demand response request;
collecting, by the at least one edge computing device, second input information from a high density computing workload scheduler, the second input information being based on power budget information of a load interfacing with the high density computing workload scheduler;
generating, first response information based on the second input information, wherein the first response information indicates a power consumption commitment;
communicating, by the at least one edge computing device, the first response information to the energy generator;
generating first command information based on the power consumption commitment, the first input information, and the second input information; and
communicating, by at least one process controller, the first command information to at least one programmable relay causing at least one threshold of the at least one programmable relay to be adjusted.

6. The method of claim 5, further comprising:
collecting, by the at least one edge computing device, third input information from a process controller board, the third input information being based on additional power budget information of a load interfacing with the process controller board.

7. The method of claim 6, further comprising:
generating, second response information based on the third input information, wherein the second response information indicates a power consumption commitment; and
communicating, by the at least one edge computing device, the second response information to the energy generator.

8. The method of claim 7, further comprising:
generating second command information based on the power consumption commitment, the first input information, and the third input information; and
communicating, by the at least one process controller, the second command information to the at least one programmable relay, causing the at least one threshold of the at least one programmable relay to be adjusted.

9. The method of claim 5, further comprising:
collecting, by the at least one edge computing device, fourth input information from an application board, the fourth input information being based on additional power budget information of a load interfacing with the application board.

10. The method of claim 9, further comprising:
generating, third response information based on the fourth input information, wherein the third response information indicates a power consumption commitment; and
communicating, by the at least one edge computing device, the third response information to the energy generator.

11. The method of claim 10, further comprising:
generating third command information based on the power consumption commitment, the first input information, and the fourth input information; and
communicating, by the at least one process controller, the third command information to the at least one programmable relay, causing the at least one threshold of the at least one programmable relay to be adjusted.

12. The method of claim 5, further comprising:
collecting, by the at least one edge computing device, fifth input information from an external network, the fifth input information being based on additional power budget information of a load interfacing with the external network.

13. The method of claim 12, further comprising:
generating, fourth response information based on the fifth input information, wherein the fourth response information indicates a power consumption commitment; and
communicating, by the at least one edge computing device, the fourth response information to the energy generator.

14. The method of claim 13, further comprising:
generating fourth command information based on the power consumption commitment, the first input information, and the fifth input information; and
communicating, by the at least one process controller, the fourth command information to the at least one programmable relay, causing the at least one threshold of the at least one programmable relay to be adjusted.

15. A system comprising:
a processor; and
a memory including instructions that, when executed by the processor, cause the processor to:
collect, by at least one edge computing device, first input information from an energy generator corresponding to a load shaving demand response request;
collect, by the at least one edge computing device, second input information from a high density computing workload scheduler, the second input information being based on power budget information of a load interfacing with the high density computing workload scheduler;
generate, first response information based on the second input information, wherein the first response information indicates a power consumption commitment;
communicate, by the at least one edge computing device, the first response information to the energy generator;
generate first command information based on the power consumption commitment, the first input information, and the second input information; and
communicate, by at least one process controller, the first command information to at least one programmable relay causing at least one threshold of the at least one programmable relay to be adjusted.

16. The system of claim 15, wherein the memory further includes instructions that, when executed by the processor, cause the processor to:
collect, by the at least one edge computing device, third input information from a process controller board, the third input information being based on additional power budget information of a load interfacing with the process controller board;
generate, second response information based on the third input information, wherein the second response information indicates a power consumption commitment;
communicate, by the at least one edge computing device, the second response information to the energy generator;
generate second command information based on the power consumption commitment, the first input information, and the third input information; and
communicate, by the at least one process controller, the second command information to the at least one programmable relay, causing the at least one threshold of the at least one programmable relay to be adjusted.

17. The system of claim 15, wherein the memory further includes instructions that, when executed by the processor, cause the processor to:
collect, by the at least one edge computing device, fourth input information from an application board, the fourth input information being based on additional power budget information of a load interfacing with the application board;
generate, third response information based on the fourth input information, wherein the third response information indicates a power consumption commitment;
communicate, by the at least one edge computing device, the third response information to the energy generator;
generate, third command information based on the power consumption commitment, the first input information, and the fourth input information; and
communicate, by the at least one process controller, the third command information to the at least one programmable relay, causing the at least one threshold of the at least one programmable relay to be adjusted.

18. The system of claim 15, wherein the memory further includes instructions that, when executed by the processor, cause the processor to:
collect, by the at least one edge computing device, fifth input information from an external network, the fifth input information being based on additional power budget information of a load interfacing with the external network.

19. The system of claim 18, wherein the memory further includes instructions that, when executed by the processor, cause the processor to:
generate, fourth response information based on the fifth input information, wherein the fourth response information indicates a power consumption commitment; and
communicate, by the at least one edge computing device, the fourth response information to the energy generator.

20. The system of claim 19, wherein the memory further includes instructions that, when executed by the processor, cause the processor to:
generate fourth command information based on the power consumption commitment, the first input information, and the fifth input information; and
communicate, by the at least one process controller, the fourth command information to the at least one programmable relay, causing the at least one threshold of the at least one programmable relay to be adjusted.
